(19) United States
(12) Patent Application Publication
(10) Pub. No.: US 2025/0065388 A1
(43) Pub. Date: Feb. 27, 2025

(54) METHOD AND MECHANICAL ARRANGEMENT FOR PROCESSING A PLASTICALLY DEFORMABLE WORKPIECE, IN PARTICULAR A PLASTICALLY DEFORMABLE PIECE OF SHEET METAL

(71) Applicant: TRUMPF Werkzeugmaschinen SE + Co. KG, Ditzingen (DE)

(72) Inventors: Patrick Wowtscherk, Neschwitz (DE); Thomas Jagemann, Ditzingen (DE); Konrad Gnauck, Neukirch (DE); Andreas Schmidt, Hochkirch (DE); Markus Wowtscherk, Ralbitz-Rosenthal/OT Schönau (DE)

(21) Appl. No.: 18/944,040

(22) Filed: Nov. 12, 2024

Related U.S. Application Data
(63) Continuation of application No. PCT/EP2023/061632, filed on May 3, 2023.

(30) Foreign Application Priority Data
May 13, 2022 (DE) 10 2022 112 073.2

(51) Int. Cl. B21D 7/08

(52) U.S. Cl. CPC B21D 7/08

(57) ABSTRACT

A method for processing a plastically deformable workpiece includes driving the workpiece using a workpiece drive so that the workpiece is moved to a feeding drive. driving the workpiece using a feeding drive so that a partial length of the workpiece is conveyed to a working region to be processed, driving the workpiece using the workpiece drive while the feeding drive has been stopped so that an intermediate length of the workpiece is arranged between the workpiece drive and the feeding drive. An advancement speed is adjusted such that the intermediate length is shorter than or equal to a maximum intermediate length. While the workpiece is being conveyed into the working region, a feeding speed of the workpiece generated by the feeding drive and the advancement speed generated by the workpiece drive are adjusted such that the intermediate length is shorter than or equal to the maximum intermediate length.

### CROSS REFERENCE TO RELATED APPLICATIONS

This application is a continuation of International Application No. PCT/EP2023/061632 (WO 2023/217601 A1), filed on May 3, 2023, and claims benefit to German Patent Application No. DE 10 2022 112 073.2, filed on May 13, 2022. The aforementioned applications are hereby incorporated by reference herein.

### FIELD

Embodiments of the present invention relate to a method for processing a plastically deformable workpiece, in particular a plastically deformable piece of sheet metal, which, in an initial state, has an initial shape which differs from an intended shape for processing.

Embodiments of the present invention also relate to a mechanical arrangement for carrying out the aforementioned processing method, to a computer program for operating such a mechanical arrangement, to a method for creating such a computer program and to a computer program product for carrying out such a method.

### BACKGROUND

Prior art of the generic type is disclosed in DE 10 2015 217 015 B3.

This document relates to a method and to a mechanical arrangement for producing a sheet metal blank. A strip of sheet metal is continuously unwound from a coil and guided through a roller straightening machine before it reaches a conveying apparatus which is arranged immediately upstream of a laser cutting device in the direction of movement of the sheet metal strip. By means of the conveying device, the sheet metal strip is transported portion by portion into the working region of the laser cutting device. In the working region of the laser cutting device, the portion of the sheet metal strip located therein is separated while the conveying device is stopped and therefore in a stopped state. Due to the continuous conveyance of sheet metal strip by means of the roller straightening machine, an open sheet metal strip loop forms upstream of the stopped conveying device between the roller straightening machine and the conveying device during a sheet metal processing step carried out in the working region of the laser cutting device, which loop grows as the processing time increases. In the case of the prior art, a looping pit is provided to accommodate the sheet metal strip loop, which looping pit requires a considerable amount of installation space and the manufacture of which involves considerable effort.

### SUMMARY

Embodiments of the present invention provide a method for processing a plastically deformable workpiece. In an initial state, the workpiece has an initial shape that differs from an intended shape for processing. The method includes plastically deforming the workpiece using at least one forming element of a straightening device, thereby changing the workpiece into the intended shape for processing. The forming element forms a workpiece drive of the straightening device. The method further includes driving the workpiece using the workpiece drive with an advancement movement in a workpiece advancement direction so that the workpiece is moved to a feeding drive arranged downstream of the workpiece drive. driving the workpiece using the feeding drive in the workpiece advancement direction so that a partial length of the workpiece is conveyed to a working region of a processing device at a feeding speed, while the feeding drive has been stopped and the partial length of the workpiece is stationary in the working region, processing the partial length of the workpiece in the working region using the processing device, and while the partial length of the workpiece is being processed in the working region, driving the workpiece using the workpiece drive in the workpiece advancement direction with an advancement speed, so that an intermediate length of the workpiece is arranged between the workpiece drive and the feeding drive. The advancement speed is adjusted such that, the intermediate length of the workpiece is shorter than or equal to a maximum intermediate length of the workpiece. While the workpiece is being conveyed into the working region, the feeding speed of the workpiece generated by the feeding drive and the advancement speed of the workpiece generated by the workpiece drive are adjusted such that the intermediate length of the workpiece arranged between the workpiece drive and the feeding drive is shorter than or equal to the maximum intermediate length of the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a mechanical arrangement for processing sheet metal immediately after a partial length of sheet metal to be processed has been conveyed into a working region of a laser cutting machine, according to some embodiments; and

FIG. 2 shows the mechanical arrangement according to FIG. 1 immediately before another partial length of the sheet metal to be processed is conveyed into the working region of the laser cutting machine, according to some embodiments.

### DETAILED DESCRIPTION

Embodiments of the present invention provide a method for processing a plastically deformable workpiece, in particular a plastically deformable piece of sheet metal, which, in an initial state, has an initial shape which differs from an intended shape for processing. The workpiece is plastically deformed by means of a straightening device and thereby made into the intended shape for processing by subjecting the workpiece to plastic deformation by means of at least one forming element of the straightening device. The forming element forms a workpiece drive of the straightening device, by means of which the workpiece is driven with an advancement movement in a workpiece advancement direction and thereby moved at an advancement speed to a feeding drive which is arranged downstream of the workpiece drive of the straightening device in the workpiece advancement direction. The workpiece is driven by means of the feeding drive in the workpiece advancement direction and a partial length thereof is thereby conveyed to a working region of a processing device at a feeding speed, wherein in the working region of the processing device on the stationary partial length of the workpiece the workpiece is processed by means of the processing device when the feeding drive has been stopped. The workpiece is driven by means of the workpiece drive of the straightening device in the workpiece advancement direction with an advancement movement and at an advancement speed, while the workpiece is being processed in the working region of the processing device and while the workpiece is being conveyed into the working region of the processing device, and an intermediate length is arranged between the workpiece drive of the straightening device and the feeding drive.

Embodiments of the present invention also relate to a mechanical arrangement for carrying out the aforementioned method. According to embodiments of the invention, the size of the mechanical arrangement and the effort associated with its manufacture can be significantly reduced.

According to embodiments of the invention, a workpiece is positioned in a working region of a processing machine in cycles. Beforehand, the workpiece passes through a straightening device in which the workpiece is given the intended shape for processing. In the straightening device, for example in a roller straightening machine, the workpiece is subjected to forming elements, if applicable straightening rollers, and thereby reshaped in the desired manner. At the same time, the forming elements drive the workpiece reshaped in the desired manner with an advancement movement performed in the direction of the processing machine of the mechanical arrangement.

The workpiece intermediate length, which is formed due to the continuous operation of the straightening device upstream of the feeding drive for the working region of the processing device, is limited in a defined manner by correspondingly controlling the advancement speed of the workpiece generated by the straightening device and the feeding speed of the workpiece generated by the feeding drive. The maximum permissible intermediate length of the workpiece can be determined depending on the specific application. For example, the spatial conditions at the installation location of the mechanical arrangement according to embodiments of the invention may be influential. By appropriately dimensioning the maximum intermediate length of the workpiece and correspondingly controlling the workpiece drive of the straightening device and the feeding drive for the working region of the processing device, which drive is arranged downstream, preferably immediately downstream, of the workpiece drive of the straightening device, it is possible to dispense with voluminous storage for the intermediate length of the workpiece, in particular underfloor storage which involves considerable manufacturing effort.

At the same time, the workpiece drive of the straightening device can be operated continuously. This avoids the formation of straightening marks on the workpiece driven in the advancement direction, which is associated with stopping and subsequently restarting the forming element(s) of the straightening device.

The advancement speed of the workpiece generated by the workpiece drive of the straightening device during workpiece processing is controlled depending on the duration for which the workpiece is processed in the working region of the processing device. For a given maximum value for the intermediate length of the workpiece between the workpiece drive of the straightening device and the feeding drive, the advancement speed of the workpiece is adjusted to an (average) value for the duration for which the workpiece is processed by controlling the workpiece drive of the straightening device, which value is lower the longer the workpiece processing lasts.

After completion of the workpiece processing step, the conveyance of the workpiece starts into the working region of the processing device by means of the previously stopped feeding drive. While the workpiece is conveyed into the working region of the processing device, a workpiece length is conveyed in the workpiece advancement direction into the space between the workpiece drive of the straightening device and the feeding drive on one side by the continuously switched-on workpiece drive of the straightening device. At the same time, a workpiece length is removed in the workpiece advancement direction from the space between the workpiece drive of the straightening device and the feeding drive by means of the feeding drive. During this operating phase of the mechanical arrangement according to embodiments of the invention, corresponding control of the workpiece drive of the straightening device and the feeding drive ensures that the value of the intermediate length of the workpiece between the workpiece drive of the straightening device and the feeding drive does not exceed the maximum value.

According to embodiments of the invention, for example a separating device, in particular a laser cutting machine, but also another type of device, such as a welding machine, can be used as the processing device for processing the workpiece.

In order to carry out the processing method according to embodiments of the invention, the mechanical arrangement according to embodiments of the invention provided with a numerical controller is controlled by means of the computer program.

The method according to embodiments of the invention and the mechanical arrangement according to embodiments of the invention are characterized in that, when the workpiece is conveyed into the working region of the processing device by means of the feeding drive, undesirable tautening of the workpiece by means of the feeding drive is avoided.

According to embodiments of the invention, a workpiece that is continuously unwound from a coil, in particular a corresponding sheet metal strip, is processed.

According to a further advantageous embodiment of the invention, the advancement speed of the workpiece generated by the workpiece drive of the straightening device is increased while the workpiece is being conveyed into the working region of the processing device. A high advancement speed of the workpiece upstream of the feeding drive for the working region of the processing device allows for a high conveying speed when transporting the workpiece into the working region of the processing device by means of the feeding drive. The dead time of the manufacturing process, which results from loading the working region of the processing device with a partial length of the workpiece to be processed, is thereby minimized.

In a further preferred embodiment of the invention, the time at which the advancement speed of the workpiece is increased is dependent on the workpiece processing status in the working region of the processing device (claim 5). Preferably, at a specified point in time before the workpiece has finished being processed, the advancement speed of the workpiece is accordingly controlled by controlling the workpiece drive of the straightening device. The relevant time before the workpiece has finished being processed can be defined in particular on the basis of the total processing time, which in turn can be stored in a numerical controller of the mechanical arrangement according to embodiments of the invention. When selecting the time during workpiece processing at which the workpiece drive of the straightening device is actuated in order to increase the advancement speed of the workpiece, the dynamics of the workpiece drive of the straightening device can be taken into account in particular and also whether and, if so, to what extent the workpiece drive of the straightening device and the feeding drive for the working region of the processing device differ in terms of their dynamics.

If, for example, the workpiece drive of the straightening device is relatively slow, the workpiece drive of the straightening device is actuated relatively early before the end of the current workpiece processing step in order to increase the advancement speed of the workpiece. If the workpiece drive of the straightening device has significantly lower dynamics than the feeding drive and if the feeding drive is started immediately after the workpiece has finished being processed, the workpiece drive of the straightening device is actuated at a greater time interval from when the workpiece has finished being processed in order to increase the advancement speed of the workpiece than in cases in which the workpiece drive of the straightening device and the feeding drive have identical or almost identical dynamics.

A numerical controller of the mechanical arrangement according to embodiments of the invention comprises a timer for controlling the workpiece drive of the straightening device and/or the feeding drive, which timer is connected to a memory of the numerical arrangement controller. The duration of a workpiece processing step is stored in the memory of the numerical arrangement controller. At a defined point in time before a current workpiece processing step has finished, the timer generates a control signal for a numerical control unit for controlling the workpiece drive of the straightening device and/or a control signal for a numerical control unit for controlling the feeding drive.

In the methods and mechanical arrangements according to embodiments of the invention, the development of the intermediate length of the workpiece, which is formed between the workpiece drive of the straightening device and the feeding drive for the working region of the processing device, is monitored before and as the workpiece is conveyed into the working region of the processing device and, if necessary, is adapted by controlling the advancement speed of the workpiece generated by the workpiece drive of the straightening device and/or by controlling the feeding speed of the workpiece generated by the feeding drive.

These features make it possible to convey the workpiece into the working region of the processing device with extremely little disturbance without the need to over-dimension the intermediate length of the workpiece between the workpiece drive of the straightening device and the feeding drive as a precaution.

According to embodiments of the invention, any differences between the dynamics of the workpiece drive of the straightening device and the dynamics of the feeding drive can be compensated for, which could otherwise lead to undesirable tautening of the workpiece by the feeding drive and/or to an undesirable delay in the process of loading the working region of the processing device and an associated delay in the overall process due to the limits according to embodiments of the invention placed on the intermediate length of the workpiece.

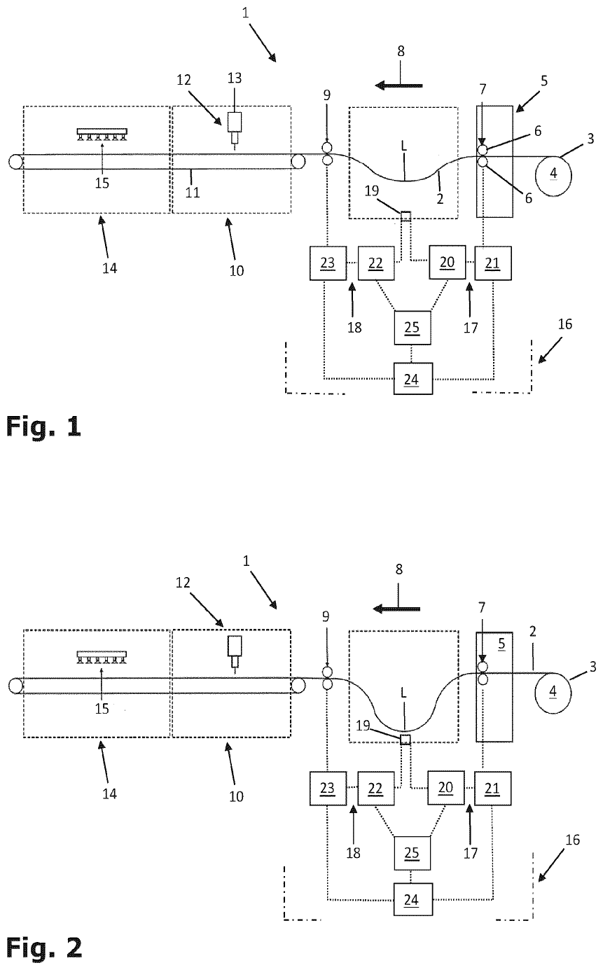

FIGS. 1 and 2 show a mechanical arrangement 1 for processing a plastically deformable workpiece in the form of a strip-shaped sheet 2. In an initial state, the sheet metal 2 is wound on a reel 4 as a coil 3. Adjacent to the reel 4 is a conventional straightening device 5 having forming elements in the form of straightening rollers 6, which form a workpiece or sheet metal drive 7 of the straightening device 5.

By means of the sheet metal drive 7 of the straightening device 5, the sheet metal 2 is continuously unwound from the coil 3 and driven with an advancement movement in a workpiece or sheet metal advancement direction (arrow 8). As a result, the sheet metal 2, which is flat after the straightening process, is moved to a feeding drive 9 of a working region 10 of the mechanical arrangement 1, which drive is arranged downstream of the sheet metal drive 7 of the straightening device 5 in the sheet metal advancement direction 8.

In the working region 10, the sheet metal 2 is placed on a workpiece support 11. A laser cutting machine 12 is arranged in the working region 10 as a processing device for separating the sheet metal 2. The laser cutting machine 12 is a conventional flatbed laser machine. For separating the partial length of the sheet metal 2 arranged in the working region 10, a laser cutting head 13 of the laser cutting machine 12 is moved in the usual way with a two-axis movement performed in a horizontal plane relative to the partial length of the sheet metal 2 resting on the workpiece support 11. The feeding drive 9 for the working region 10 is stopped during the separation of the sheet metal 2.

The working region 10 is followed in the sheet metal advancement direction 8 by an unloading region 14 of the mechanical arrangement 1. In the unloading region 14, sheet metal parts produced in the working region 10 and a skeleton scrap generated as a waste product of sheet metal working are removed from the workpiece support 11 by means of a conventional suction frame 15. The sheet metal parts and the skeleton scrap are then transported by means of the suction frame 15 to a workpiece deposit (not shown) or to a skeleton scrap deposit (also not shown).

All substantial functions of the mechanical arrangement 1 are controlled by means of a numerical arrangement controller 16.

The arrangement controller 16 comprises a numerical control unit 17 for controlling the sheet metal drive 7 of the straightening device 5 and a numerical control unit 18 for controlling the feeding drive 9.

The control unit 17 of the sheet metal drive 7 in turn comprises a measuring device 19, a comparison unit 20 and an adjustment unit 21.

The measuring device 19 is simultaneously part of the control unit 18 for the feeding drive 9. In addition to the measuring device 19, the control unit 18 for the feeding drive 9 has a comparison unit 22 and an adjustment unit 23.

Also provided are a timer 24 and a memory 25 of the arrangement controller 16 connected to the timer 24.

FIG. 1 shows the conditions on the mechanical arrangement 1 immediately after a partial length of the sheet metal 2 to be processed has been conveyed to the working region 10 of the laser cutting machine 12 by means of the feeding drive 9. The feeding drive 9 for the working region 10 is stopped, an intermediate length L of the sheet metal 2 formed between the feeding drive 9 for the working region 10 and the sheet metal drive 7 of the straightening device 5 has a minimum value in the snapshot in FIG. 1.

The sheet metal drive 7 of the straightening device 5 is operated continuously and consequently drives the sheet metal 2 with an advancement movement in the sheet metal advancement direction 8 even during the sheet metal processing step in the working region 10. Due to the simultaneous stopping of the feeding drive 9, the intermediate length L of the sheet metal 2 thus increases during the sheet metal processing step.

As a result of correspondingly controlling the sheet metal drive 7 of the straightening device 5 by means of the control unit 17 of the arrangement controller 16, the sheet metal 2 advances at such an advancement speed generated by the sheet metal drive 7 of the straightening device 5 when the feeding drive 9 is stopped that the value of the intermediate length L of the sheet metal 2 does not exceed a maximum value when the workpiece processing step in the working region 10 is completed. A value is specified for the maximum intermediate length L of the sheet metal 2, due to which the intermediate length L can be accommodated in a comparatively small installation space between the straightening device 5 and the feeding drive 9. Consequently, in particular an underfloor storage facility for accommodating the intermediate length L of the sheet metal 2 can be dispensed with.

The advancement speed of the sheet metal 2 is not kept constant during the sheet metal processing step in the working space 10, but instead varies.

In the initial stage of sheet metal processing, the advancement speed of the sheet metal 2 is adjusted to a relatively low value by means of the control unit 17 for the sheet metal drive 7 of the straightening device 5. Shortly before the sheet metal processing step is complete, the advancement speed of the sheet metal 2 is then significantly increased.

The time at which the increase of the advancement speed of the sheet metal 2 is started during the sheet metal processing step in the working region 10 is specified depending on the dynamics of the sheet metal drive 7 of the straightening device 5. The slower the sheet metal drive 7 is, the sooner the advancement speed of the sheet metal 2 is increased. At the time established depending on the dynamics of the sheet metal drive 7, the adjustment unit 21 of the control device 17 causes a corresponding change in the advancement speed of the sheet metal 2 by correspondingly actuating the sheet metal drive 7.

The trigger for the actuation of the sheet metal drive 7 by means of the adjustment unit 21 of the control device 17 is a control signal which the timer 24 generates for the adjustment unit 21 at the relevant time at which the sheet metal is being processed in the working space 10. The timer 24 accesses the memory 25 of the arrangement controller 16, in which memory 25 the duration for which the sheet metal is processed in the working space 10 is stored.

At a time that is dependent on the dynamics of the feeding drive 9 before the sheet metal processing step in the working space 10 has ended, the timer 24 also generates a control signal for the adjustment unit 23 of the control unit 18 for the feeding drive 9. This ensures that the feeding drive 9 begins conveying the next partial length of the sheet metal 2 to be processed into the working region 10 upon completion of the sheet metal processing step or, if necessary, immediately thereafter.

At this point in time, the mechanical arrangement 1 is shown in FIG. 2. The intermediate length L of the sheet metal 2 has its maximum value.

While the sheet metal drive 7 of the straightening device 5 arranged upstream of the feeding drive 9 drives the sheet metal 2 at the already increased advancement speed in the sheet metal advancement direction 8 and thereby increases the intermediate length L of the sheet metal 2 considered in isolation, the activated feeding drive 9 causes a further partial length of the sheet metal 2 to be conveyed to the working region 10 and thereby reduces the intermediate length L of the sheet metal 2 considered in isolation.

Since, in the example case shown, the feeding speed of the sheet metal 2 generated by means of the feeding drive 9 is faster than the advancement speed of the sheet metal 2 generated by means of the sheet drive 7 of the straightening device 5, the intermediate length L of the sheet metal 2 between the sheet metal drive 7 and the feeding drive 9 is shortened during the synchronous operation of the sheet metal drive 7 of the straightening device 5 and the feeding drive 9.

Correspondingly controlling the sheet metal drive 7 of the straightening device 5 by means of the control unit 17 and correspondingly controlling the feeding drive 9 for the working region 10 by means of the control unit 18 ensures, on the one hand, that the intermediate length L with which the sheet metal 2 is arranged between the sheet metal drive 7 and the feeding drive 9 when the sheet metal 2 is conveyed into the working region 10 does not exceed the maximum intermediate length L of the sheet metal 2 at any time either. On the other hand, the coordinated control of the sheet metal drive 7 of the straightening device 5 and the feeding drive 9 ensures that the sheet metal 2 is not stretched in an undesirable manner on the side facing the straightening device 5 when it is conveyed into the working region 10 by the feeding drive 9.

As soon as the partial length of the sheet metal 2 to be processed in the next step is conveyed into the working region 10, the conditions according to FIG. 1 are provided again.

As a result of feeding the sheet metal 2 into the working space 10 of the laser cutting machine 12, the previously processed partial length of the sheet metal 2 reaches the unloading region 14 of the mechanical arrangement 1, where the sheet metal parts created during processing and the skeleton scrap are unloaded from the workpiece support 11 by means of the suction frame 15.

In order to ensure that the intermediate length L of the sheet metal 2 does not exceed the maximum value either during the sheet metal processing step in the working region 10 of the laser cutting machine 12 or as the sheet metal 2 is conveyed into the working region 10, and in order to avoid undesirable stretching of the sheet metal 2 as it is conveyed into the working region 10, the momentary actual value of the intermediate length L is continuously measured by means of the measuring device 19 and compared in the comparison units 20, 22 of the control units 17, 18 for the sheet metal drive 7 and the feeding drive 9 with a momentary target value which is stored in the memory 25 of the arrangement controller 16 for the specific application.

Depending on the result of the actual value-target value comparison, the momentary advancement speed of the sheet metal 2 generated by means of the sheet metal drive 7 of the straightening device 5 and/or the momentary feeding speed of the sheet metal 2 generated by means of the feeding drive 9 is either kept constant or accordingly controlled by means of the adjustment units 21, 23.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for processing a plastically deformable workpiece, wherein in an initial state, the workpiece has an initial shape that differs from an intended shape for processing, the method comprising:
plastically deforming the workpiece using at least one forming element of a straightening device, thereby changing the workpiece into the intended shape for processing, wherein the forming element forms a workpiece drive of the straightening device,
driving the workpiece using the workpiece drive with an advancement movement in a workpiece advancement direction so that the workpiece is moved to a feeding drive arranged downstream of the workpiece drive,
driving the workpiece using the feeding drive in the workpiece advancement direction so that a partial length of the workpiece is conveyed to a working region of a processing device at a feeding speed,
while the feeding drive has been stopped and the partial length of the workpiece is stationary in the working region, processing the partial length of the workpiece in the working region using the processing device, and
while the partial length of the workpiece is being processed in the working region, driving the workpiece using the workpiece drive in the workpiece advancement direction with an advancement speed, so that an intermediate length of the workpiece is arranged between the workpiece drive and the feeding drive, wherein the advancement speed is adjusted such that, the intermediate length of the workpiece is shorter than or equal to a maximum intermediate length of the workpiece,
wherein while the workpiece is being conveyed into the working region, the feeding speed of the workpiece generated by the feeding drive and the advancement speed of the workpiece generated by the workpiece drive are adjusted such that the intermediate length of the workpiece arranged between the workpiece drive and the feeding drive is shorter than or equal to the maximum intermediate length of the workpiece.

2. The method according to claim 1, wherein while the workpiece is being conveyed into the working region, the feeding speed of the workpiece generated by the feeding drive and the advancement speed of the workpiece generated by the workpiece drive are adjusted such that the intermediate length of the workpiece is equal to or greater than a minimum intermediate length of the workpiece, wherein at the minimum intermediate length of the workpiece, the intermediate length of the workpiece is free from tensile stress that results from the workpiece being conveyed by the feeding drive.

3. The method according to claim 1, wherein the workpiece comprises a piece of sheet metal, wherein in the initial state, the workpiece forms a coil as the initial shape, and the intended shape for processing is flat.

4. The method according to claim 1, wherein the advancement speed of the workpiece generated by the workpiece drive is adjusted to a higher value while the workpiece is being conveyed into the working region than while the partial length of the workpiece is being processed in the working region.

5. The method according to claim 4, wherein the advancement speed of the workpiece generated by the workpiece drive is adjusted depending on a processing status in the working region.

6. The method according to claim 1, further comprising, while the partial length of the workpiece is being processed in the working region,
measuring at least one actual value for the intermediate length of the workpiece as a momentary actual value, and
comparing the momentary actual value for the intermediate length of the workpiece with a momentary target value of the intermediate length of the workpiece in an actual value-target value comparison,
wherein the advancement speed of the workpiece generated by the workpiece drive is adjusted depending on a result of the actual value-target value comparison.

7. The method according to claim 1, further comprising, while the workpiece is being conveyed into the working region,
measuring at least one actual value for the intermediate length of the workpiece as a momentary actual value for the intermediate length of the workpiece, and
comparing the momentary actual value for the intermediate length of the workpiece with a momentary target value of the intermediate length of the workpiece in an actual value-target value comparison,
wherein the advancement speed of the workpiece generated by the workpiece drive and/or the feeding speed of the workpiece generated by the feeding drive is adjusted depending on a result of the actual value-target value comparison.

8. A mechanical arrangement for processing a plastically deformable workpiece, wherein in an initial state, the workpiece has an initial shape that differs from an intended shape for processing, the mechanical arrangement comprising:
a straightening device having at least one forming element for deforming the workpiece from the initial shape into the intended shape for processing, wherein the forming element forms a workpiece drive configured for driving the workpiece with an advancement movement in a workpiece advancement direction, thereby moving the workpiece to a feeding drive arranged downstream of the workpiece drive,
a feeding drive configured for driving the workpiece in the workpiece advancement direction, thereby a partial length of the workpiece is conveyable to a working region of a processing device at a feeding speed, wherein the partial length of the workpiece in the working region is processable by the processing device as the feeding drive has been stopped and the partial length of the workpiece is stationary, and
an arrangement controller comprising a first control unit for controlling the workpiece drive and a second control unit for controlling the feeding drive,
wherein the first control unit is configured to, while the partial length of the workpiece is being processed in the working region, adjust the advancement speed of the workpiece generated by the workpiece drive such that an intermediate length of the workpiece arranged between the workpiece drive and the feeding drive is shorter than or equal to a maximum intermediate length of the workpiece, and
wherein the first control unit for controlling the workpiece drive and the second control unit for controlling the feeding drive are configured to, while the workpiece is being conveyed into the working region, adjusting the feeding speed of the workpiece generated by the feeding drive and the advancement speed of the workpiece generated by the workpiece drive such that the intermediate length of the workpiece arranged between the workpiece drive and the feeding drive is shorter than or equal to the maximum intermediate length of the workpiece.

9. The mechanical arrangement according to claim 8, wherein, while the workpiece is being conveyed into the working region, the feeding speed of the workpiece generated by the feeding drive and the advancement speed of the workpiece generated by the workpiece drive are adjusted such that the intermediate length of the workpiece arranged between the workpiece drive and the feeding drive is equal to or greater than a minimum intermediate length of the workpiece, wherein at the minimum intermediate length of the workpiece, the intermediate length of the workpiece is free from tensile stress that results from the workpiece being conveyed by the feeding drive.

10. The mechanical arrangement according to claim 8, wherein the first control unit for controlling the workpiece drive comprises a measuring device, a comparison unit, and an adjustment unit,
wherein, while the partial length of the workpiece is being processed in the working region,
the measuring device is configured to measure at least one actual value for the intermediate length of the workpiece as a momentary actual value for the intermediate length of the workpiece,
the comparison unit is configured to compare the momentary actual value for the intermediate length of the workpiece with a momentary target value of the intermediate length of the workpiece in an actual value-target value comparison, and
the adjustment unit is configured to adjust the advancement speed of the workpiece generated by the workpiece drive depending on a result of the actual value-target value comparison.

11. The mechanical arrangement according to claim 8, wherein the second control unit for controlling the feeding drive comprising a measuring device, a comparison unit, and an adjustment unit,
wherein, while the workpiece is being conveyed into the working region,
the measuring device is configured to measure at least one actual value for the intermediate length of the workpiece as a momentary actual value for the intermediate length of the workpiece,
the comparison unit is configured to compare the momentary actual value for the intermediate length of the workpiece with a momentary target value for the intermediate length of the workpiece in an actual value-target value comparison, and
the adjustment unit is configured to adjust the feeding speed of the workpiece generated by the feeding drive depending on a result of the actual value-target value comparison.

12. A non-transitory computer-readable medium having a computer program stored thereon, the computer program, when executed by a computer processor, causing performance of a method according to claim 1.
